(19) United States
(12) Patent Application Publication
(10) Pub. No.: US 2012/0224113 A1
(43) Pub. Date: Sep. 6, 2012

(54) Reflective Type Complex Display Device and Method of Manufacturing the Same

(75) Inventors: Il-Soo Oh, Yongin-city (KR); Chang-Ho Lee, Yongin-city (KR); Hee-Joo Ko, Yongin-city (KR); Se-Jin Cho, Yongin-city (KR); Hyung-Jun Song, Yongin-city (KR); Jin-Young Yun, Yongin-city (KR); Bo-Ra Lee, Yongin-city (KR); Young-Woo Song, Yongin-city (KR); Jong-Hyuk Lee, Yongin-city (KR); Sung-Chul Kim, Yongin-city (KR)

(73) Assignee: SAMSUNG MOBILE DISPLAY CO., LTD., Yongin-City (KR)

(21) Appl. No.: 13/347,151

(22) Filed: Jan. 10, 2012

(30) Foreign Application Priority Data
Mar. 4, 2011 (KR) 10-2011-0019333

(51) Int. Cl. G02F 1/133; H01J 9/24

(52) U.S. Cl. 349/33; 445/24

(57) ABSTRACT

A reflective type complex display device comprises: a lower substrate; an organic light-emitting layer formed on a top surface of the lower substrate for emitting light when supplied with current; a sealing layer covering the organic light-emitting layer so as to seal the organic light-emitting layer from the outside; an upper substrate formed above the sealing layer with a gap therebetween; liquid crystals injected between the upper substrate and the sealing layer; a transparent electrode formed on a surface of the upper substrate; and a polarizer formed on another surface of the upper substrate. The transparent electrode comprises a first electrode and a second electrode which are alternately arranged, and which drive the liquid crystals by generating an electric field in response to different voltages applied thereto.

### CLAIM OF PRIORITY

This application makes reference to, incorporates the same herein, and claims all benefits accruing under 35 U.S.C. §119 from an application earlier filed in the Korean Intellectual Property Office on the 4 Mar. 2011 and there duly assigned Serial No. 10-2011-0019333.

### BACKGROUND OF THE INVENTION

1. Field of the Invention

The present invention relates to a reflective type complex display device and a method of manufacturing the same, and more particularly, to a reflective type complex display device which selectively drives an organic light-emitting element and/or liquid crystals according to the intensity of external light and a method of manufacturing the reflective type complex display device.

2. Description of the Related Art

The rapid development of the information technology (IT) industry is dramatically increasing the use of display devices. Recently, there have been demands for display devices which are lightweight and thin, consume low power and provide high resolution. To meet these demands, liquid crystal displays or organic light-emitting display devices using organic light-emitting characteristics are being developed.

Organic light-emitting display devices, which are next-generation display devices having self light-emitting characteristics, have better characteristics than liquid crystal displays in terms of viewing angle, contrast, response speed and power consumption, and can be manufactured so as to be thin and lightweight since a backlight is not required.

Organic light-emitting display devices have far higher contrast than liquid crystal displays. However, their visibility may be reduced when the intensity of incident external light is greater than a predetermined value. To solve this problem, a reflective type complex display device which can be driven in both an organic light-emitting mode and a reflective type liquid crystal mode has been suggested.

The conventional reflective type complex display device combines the advantage of the organic light-emitting mode (providing higher contrast in lower ambient brightness conditions) and the advantage of the reflective type liquid crystal mode (providing higher contrast in higher ambient brightness conditions). In an indoor environment, where external light is weak, the conventional reflective type complex display device is driven in the organic light-emitting mode so as to display information through self light emission of an emitting layer. The liquid crystals LC serve as a λ/4 phase difference plate which makes incident external light disappear, thereby preventing a reduction in contrast.

However, the conventional reflective type complex display device requires a second electrode on the emitting layer. The second electrode is deposited on the emitting layer by sputtering. During the sputtering process, metal atoms may damage part of the emitting layer. In addition, a photoresist process, a heat treatment process and a rubbing process for the alignment of the liquid crystals which are needed in the process of patterning the second electrode may also damage the emitting layer. The damaged emitting layer reduces element reliability and results in non-uniform luminance.

### SUMMARY OF THE INVENTION

The present invention provides a reflective type complex display device which can switch between a reflective type liquid crystal mode and an organic light-emitting mode according to the intensity of external light, and in which no electrode is formed on the organic light-emitting layer so as to improve element reliability and stability of the organic light-emitting layer.

However, aspects of the present invention are not restricted to the ones set forth herein. The above and other aspects of the present invention will become more apparent to one of ordinary skill in the art to which the present invention pertains by referencing the detailed description of the present invention given below.

According to an aspect of the present invention, there is provided a reflective type complex display device comprising: a lower substrate; an organic light-emitting layer formed on a top surface of the lower substrate and emitting light when supplied with current; a sealing layer covering the organic light-emitting layer so as to seal the organic light-emitting layer from the outside; an upper substrate formed above the sealing layer with a gap therebetween; liquid crystals injected between the upper substrate and the sealing layer; a transparent electrode formed on a surface of the upper substrate; and a polarizer formed on the other surface of the upper substrate; wherein the transparent electrode comprises a first electrode and a second electrode which are alternately arranged, and which drive the liquid crystals by generating an electric field in response to different voltages applied thereto.

According to another aspect of the present invention, there is provided a reflective type complex display device comprising: a flexible lower substrate; an organic light-emitting layer formed on a top surface of the lower substrate and emitting light when supplied with current; a thin organic complex sealing layer covering the organic light-emitting layer so as to seal the organic light-emitting layer from the outside; a flexible upper substrate formed above the sealing layer with a gap therebetween; liquid crystals injected between the upper substrate and the sealing layer; a transparent electrode formed on a surface of the upper substrate; and a polarizer formed on the other surface of the upper substrate; wherein the transparent electrode comprises a first electrode and a second electrode which are alternately arranged, and which drive the liquid crystals by generating an electric field in response to different voltages applied thereto.

According to another aspect of the present invention, there is provided a method of manufacturing a reflective type complex display device, the method comprising: providing an upper substrate and a lower substrate; forming an organic light-emitting layer on the lower substrate; forming a sealing layer on the organic light-emitting layer; forming a patterned transparent electrode on a surface of the upper substrate; bonding the upper substrate and the lower substrate together so that the surface of the upper substrate faces the sealing layer of the lower substrate; and injecting liquid crystals between the upper substrate and the lower substrate; wherein the transparent electrode comprises a first electrode and a second electrode which are alternately arranged, and which drive the liquid crystals by generating an electric field in response to different voltages applied thereto.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view of a reflective type complex display device;

FIG. 2 is a flowchart illustrating a method of manufacturing the reflective type complex display device;

FIG. 3 is a cross-sectional view of a reflective type complex display device according to an exemplary embodiment of the present invention;

FIG. 4 is a plan view of a transparent electrode shown in FIG. 3;

FIGS. 5A and 5B are views showing liquid crystals driven by a voltage applied to the transparent electrode of FIG. 4;

FIG. 6 is a cross-sectional view of the reflective type complex display device of FIG. 3 which is driven in a reflective type liquid crystal mode;

FIG. 7 is a detailed cross-sectional view of an organic light-emitting layer included in the reflective type complex display device of FIG. 3;

FIG. 8 is a cross-sectional view of a reflective type complex display device according to another exemplary embodiment of the present invention; and

FIG. 9 is a flowchart illustrating a method of manufacturing a reflective type complex display device according to an exemplary embodiment of the present invention.

### DETAILED DESCRIPTION OF THE INVENTION

The present invention will now be described more fully with reference to the accompanying drawings, in which preferred embodiments of the invention are shown. This invention may, however, be embodied in different forms, and should not be construed as limited to the embodiments set forth herein. Rather, these embodiments are provided so that this disclosure will be thorough and complete, and will fully convey the scope of the invention to those skilled in the art. The same reference numbers indicate the same components throughout the specification. In the attached figures, the thickness of layers and regions is exaggerated for clarity.

It will also be understood that, when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description so as to describe the relationship of one element or feature to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device maybe otherwise oriented (rotated 90 degrees or at other orientations) and the spatially relative descriptors used herein interpreted accordingly.

The use of the terms “a”, “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted.

Unless defined otherwise, all technical and scientific terms used herein have the same meaning as commonly understood by one of ordinary skill in the art to which this invention pertains. It is noted that the use of any and all examples, or exemplary terms provided herein, is intended merely to better illuminate the invention and is not a limitation on the scope of the invention unless otherwise specified. Furthermore, unless defined otherwise, all terms defined in generally used dictionaries may not be overly interpreted.

The present invention will be described with reference to perspective views, cross-sectional views, and/or plan views, in which preferred embodiments of the invention are shown. Thus, the profile of an exemplary view may be modified according to manufacturing techniques and/or allowances. That is, the embodiments of the invention are not intended to limit the scope of the present invention but cover all changes and modifications which can be caused due to a change in manufacturing process. Thus, regions shown in the drawings are illustrated in schematic form and the shapes of the regions are presented simply by way of illustration and not as a limitation.

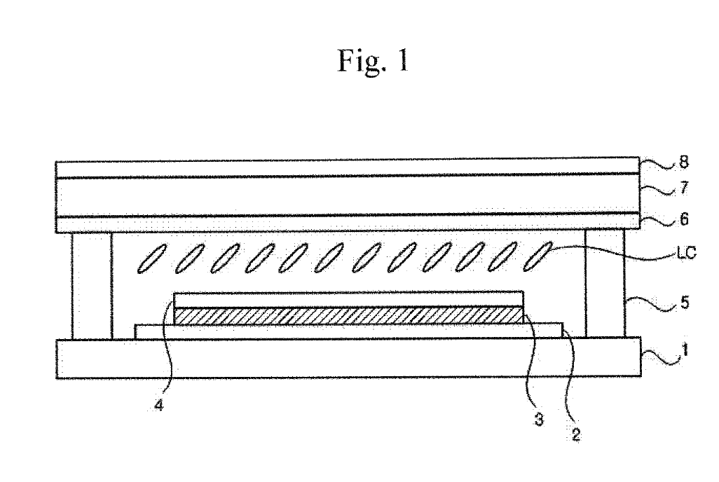

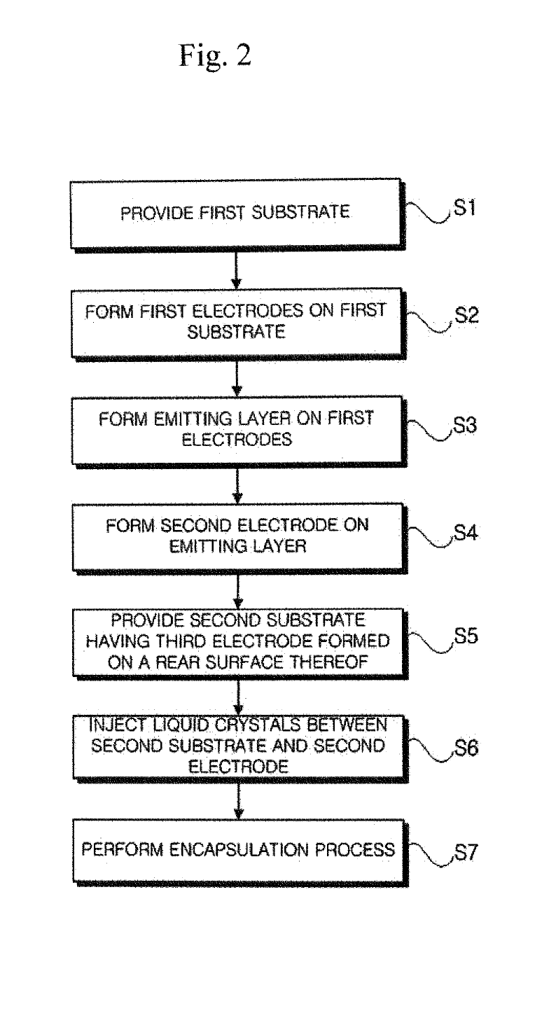

Hereinafter, the structure of a reflective type complex display device and a method of manufacturing the reflective type complex display device will be described with reference to FIGS. 1 and 2.

FIG. 1 is a cross-sectional view of a reflective type complex display device, and FIG. 2 is a flowchart illustrating a method of manufacturing the reflective type complex display device.

Referring to FIGS. 1 and 2, a first substrate 1 on which thin-film transistors are to be formed is provided (operation S1). A plurality of first electrodes 2 are formed on a top surface of the first substrate 1 and are arranged in a striped pattern at predetermined intervals (operation S2). An emitting layer 3 is formed on a top surface of each of the first electrodes 2 (operation S3), and a plurality of second electrodes 4 are formed in a striped pattern on a top surface of the emitting layer 3 and are placed orthogonal to the first electrodes 2 (operation S4).

After each of the first electrodes 2, the emitting layer 3, and the second electrode 4 are sequentially stacked to form an organic light-emitting display unit, a second substrate 7 is positioned above the first substrate 1 and is separated a predetermined distance from the first substrate 1 by sealants 5 (operation S5), wherein the second substrate 7 has a third electrode 6 formed on a surface thereof and a polarizer 8 formed on the other surface thereof. Then, liquid crystals LC are injected between the first and second substrates 1 and 7, respectively (operation S6), and are sealed by an encapsulation process (operation S7).

The first electrodes 2 may be made of a metal, such as Ca, Mg or Al, or an alloy of these metals. The first electrodes 2 may be deposited by vacuum deposition, spin coating, inkjet printing, or dipping. The second and third electrodes 4 and 6, respectively, are made of a transparent electrode material which allows light emitted from the emitting layer 3 to exit an element. Specifically, the second and third electrodes 4 and 6, respectively, may be made of indium tin oxide (ITO) or indium zinc oxide (IZO), and may be deposited using a sputtering method. In an initial state, that is, when no voltage is applied, the liquid crystals LC have a phase difference of λ/4, a value obtained using the difference in double refraction Δn and thickness d.

The reflective type complex display device combines the advantage of the organic light-emitting mode (providing higher contrast in lower ambient brightness conditions) and the advantage of the reflective type liquid crystal mode (providing higher contrast in higher ambient brightness conditions). In an indoor environment where external light is weak, the reflective type complex display device is driven in the organic light-emitting mode so as to display information through self light emission of the emitting layer 3. In this regard, the liquid crystals LC serve as a λ/4 phase difference plate which makes incident external light disappear, thereby preventing a reduction in contrast.

However, the reflective type complex display device requires the second electrode 4 on the emitting layer 3. As described above, the second electrode 4 is deposited on the emitting layer 3 by sputtering. During the sputtering process, metal atoms may damage part of the emitting layer 3. In addition, a photoresist process, a heat treatment process and a rubbing process for the alignment of the liquid crystals LC which are needed in the process of patterning the second electrode 4 may also damage the emitting layer 3. The damaged emitting layer 3 reduces element reliability and results in non-uniform luminance.

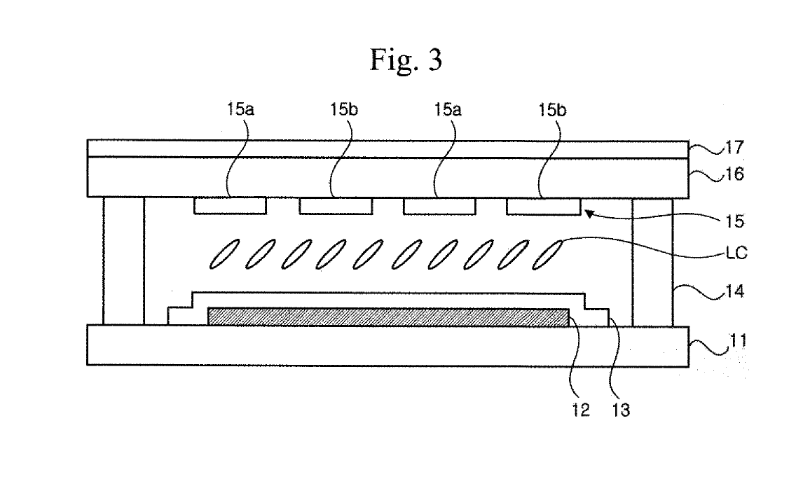

Hereinafter, a reflective type complex display device according to an exemplary embodiment of the present invention will be described with reference to FIGS. 3 thru 7.

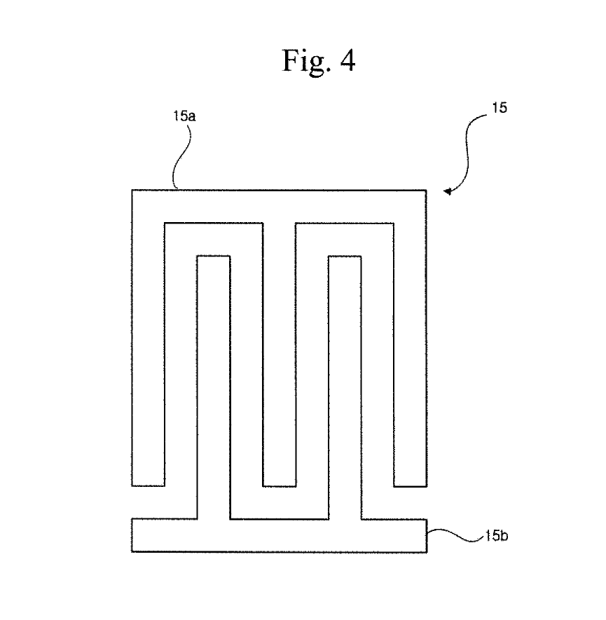

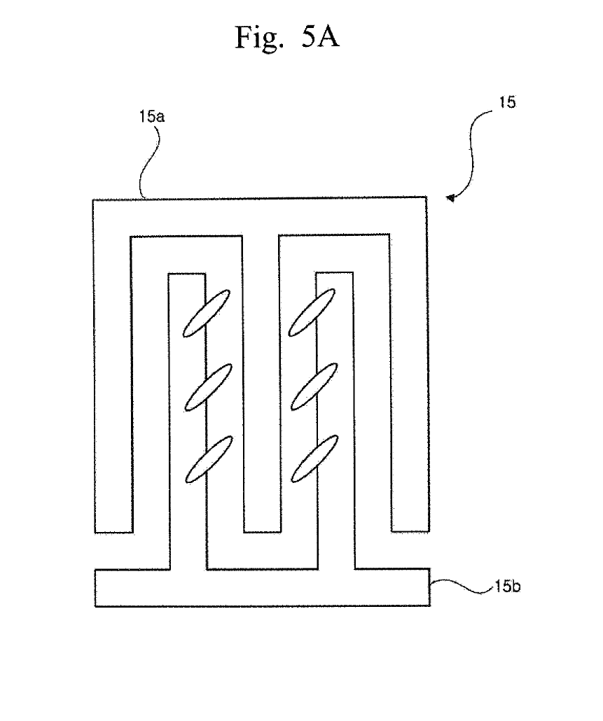

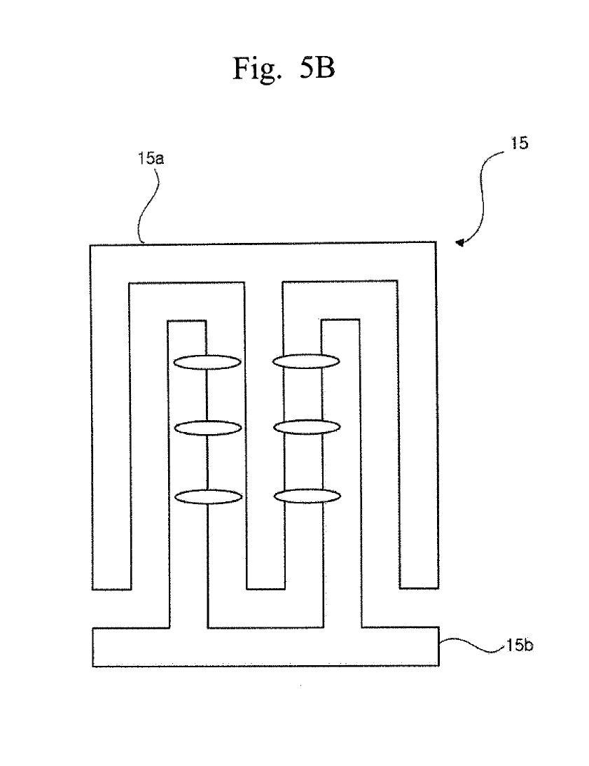

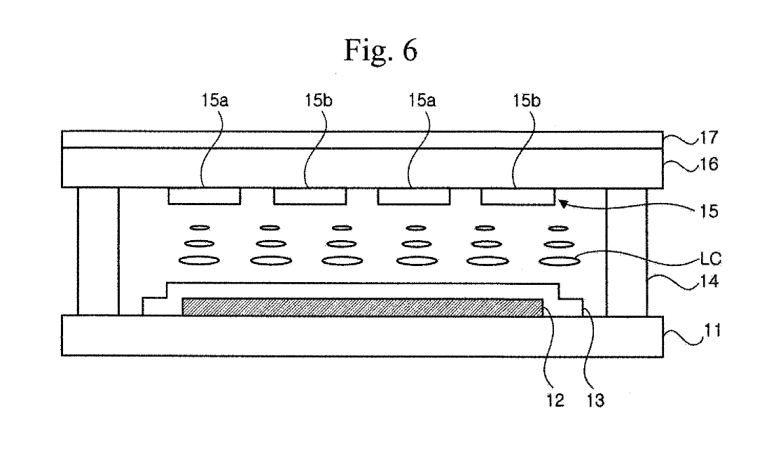

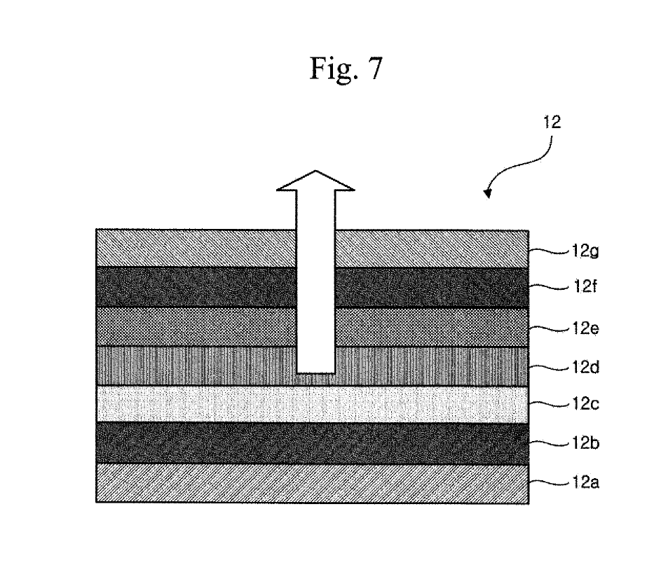

FIG. 3 is a cross-sectional view of a reflective type complex display device according to an exemplary embodiment of the present invention, FIG. 4 is a plan view of a transparent electrode shown in FIG. 3, FIGS. 5A and 5B are views showing liquid crystals driven by a voltage applied to the transparent electrode of FIG. 4, FIG. 6 is a cross-sectional view of the reflective type complex display device of FIG. 3 which is driven in a reflective type liquid crystal mode, and FIG. 7 is a detailed cross-sectional view of an organic light-emitting layer included in the reflective type complex display device of FIG. 3.

The reflective type complex display device according to the current exemplary embodiment includes a lower substrate 11, an organic light-emitting layer 12 formed on a top surface of the lower substrate 11 and emitting light when supplied with current, a sealing layer 13 covering the organic light-emitting layer 12 so as to seal the organic light-emitting layer 12 from the outside, an upper substrate 16 formed above the sealing layer 13 with a gap therebetween, liquid crystals LC injected between the upper substrate 16 and the sealing layer 13, a transparent electrode 15 formed on a surface of the upper substrate 16, and a polarizer 17 formed on the other surface of the upper substrate 16. The transparent electrode 15 includes a first electrode 15a and a second electrode 15b which are alternately arranged, and which drive the liquid crystals LC by generating an electric field in response to different voltages applied thereto.

Specifically, the lower substrate 11 may be made of a transparent glass material containing SiO₂ as a main component. However, the material which forms the lower substrate 11 is not limited to the transparent glass material. The lower substrate 11 may also be made of a transparent plastic material. The plastic material which forms the lower substrate 11 may be an insulating organic material selected from the group consisting of polyethersulphone (PES), polyacrylate (PAR), polyetherimide (PEI), polyethylene napthalate (PEN), polyethylene terephthalate (PET), polyphenylene sulfide (PPS), polyallylate, polyimide, polycarbonate (PC), cellulose triacetate (TAC), and cellulose acetate propionate (CAP).

In a bottom emission display device in which an image is realized toward the lower substrate 11, the lower substrate 11 should be made of a transparent material. However, in a top emission display device in which an image is realized away from the lower substrate 11, the lower substrate 11 may not necessarily be made of a transparent material. In this case, the lower substrate 11 may be made of metal. When the lower substrate 11 is made of metal, it may contain one or more materials selected from the group consisting of C, Fe, Cr, Mn, Ni, Ti, Mo, and stainless steel (SUS). However, the material which forms the lower substrate 11 is not limited to the above materials. The lower substrate 11 may also be made of metal foil.

A buffer layer (not shown) may further be formed on the lower substrate 11 so as to planarize the lower substrate 11 and prevent penetration of impurities into the lower substrate 11. The buffer layer may be a single layer of SiOx, SiNx or SiO₂Nx, or a multilayer of these materials.

The organic light-emitting layer 12 is formed on the lower substrate 11. As shown in FIG. 7, the organic light-emitting layer 12 includes an anode electrode 12a, a hole injecting layer 12b, a hole transporting layer 12c, an emitting layer 12d, an electron transporting layer 12e, an electron injecting layer 12f, and a cathode electrode 12g stacked sequentially.

In a bottom emission organic light-emitting display device, the anode electrode 12a may be a transparent conductive material such as indium tin oxide (ITO) or indium zinc oxide (IZO). In the top emission reflective type complex display device according to the current exemplary embodiment, the anode electrode 12a may be made of a metal oxide with a high work function, such as Al₂O₃ or ZnO.

A reflective film (not shown) may further be formed between the lower substrate 11 and the anode electrode 12a. The reflective film included in the top emission reflective type complex display device according to the current exemplary embodiment reflects light which is emitted from the emitting layer 12d toward the back side of the display device so that the light proceeds toward the front side, thereby improving light efficiency.

The reflective film brings about an optical resonance effect between itself and the cathode electrode 12g so as to enable more light to proceed toward the cathode electrode 12g.

The reflective film may be made of any material, preferably, a material with high light reflectance, such as metal. The thickness of the reflective film may also be adjusted to ensure sufficient light reflection. The reflective film may be made of Al, Ag, Cr or Mo, and may be formed to a thickness of approximately 1,000 Å.

Holes injected from the hole injecting layer 12b and electrons injected from the electron injecting layer 12f combine together in the emitting layer 12d to generate light, and the generated light is emitted upward in FIGS. 3 and 7 so as to pass through the cathode electrode 12g and then exit the display device.

The organic light-emitting layer 12 may further include an auxiliary hole transporting layer (not shown) which helps holes to easily reach the emitting layer 12d.

The cathode electrode 12g generates current together with the anode electrode 12a thereunder, thereby causing the emitting layer 12d to emit light. In the reflective type complex display device according to the current exemplary embodiment, the cathode electrode 12g may be made of a material which allows light to pass therethrough, specifically, a metal with a low work function. The cathode electrode 12g may be formed thin so as to be able to be a semi-transmissive reflection. A metal with a low work function, such as Mg, Ag, Al, Au or Cr, may be used for the cathode electrode 12g.

The sealing layer 13 is formed on the organic light-emitting layer 12 and seals the organic light-emitting layer 12 from the outside. As described above with reference to FIG. 1, in the reflective type complex display device, the second electrode 4 containing a transparent conductive oxide is formed directly on the emitting layer 3. Therefore, the emitting layer 3 can be damaged in the process of depositing or patterning the second electrode 4. On the other hand, in the reflective type complex display device according to the current exemplary embodiment of the invention, the organic light-emitting layer 12 is capped with the sealing layer 13, and no electrode is deposited on the organic light-emitting layer 12. Therefore, damage to the organic light-emitting layer 12 can be prevented.

The sealing layer 13 may be made of a material which allows light to transmit therethrough, so that light emitted from the organic light-emitting layer 12 can proceed upward in FIG. 3.

The upper substrate 16 is separated a predetermined distance from the lower substrate 11 by sealants 14. The upper substrate 16 may be made of the same material as the lower substrate 11.

The liquid crystals LC are injected into the space between the upper substrate 16 and the lower substrate 11, specifically, the space between the sealing layer 13 of the lower substrate 11 and the transparent electrode 15 of the upper substrate 16.

A liquid crystal composition injected between the upper substrate 16 and the lower substrate 11 may be made of a liquid crystal compound which has a mesogenic group containing a cyclic unit, etc. in a molecular structure. Examples of the mesogenic group containing the cyclic unit, etc. include a biphenyl group, a phenylbenzoate group, a phenylcyclohexane group, an azoxybenzene group, an azomethine group, an azobenzene group, a phenylpyrimidine group, a diphenylacetylene group, a diphenylbenzoate group, a bicyclohexane group, a cyclohexylbenzene group, and a terphenyl group. The terminals of the cyclic unit may have a substituent such as a cyano group, an alkyl group, an alkoxy group, or a halogen group. In some embodiments, the mesogenic group containing the cyclic unit, etc. may have a biphenyl group or a phenylbenzoate group.

The liquid crystal compound may have at least one polymer functional group in a part of a molecule. Examples of the polymer functional group include an acryloyl group, a methacryloyl group, an epoxy group, and a vinyl ether group. Alternatively, the liquid crystal compound may have two or more polymer functional groups in a part of a molecule. Thus, a cross-linking structure formed by polymerization may increase durability.

The polarizer 17 is formed on a surface of the upper substrate 16. The polarizer 17 selectively transmits incident light or exit light having various phases. For example, the polarizer 17 transmits light of a predetermined wavelength only, e.g., a horizontal wave. Accordingly, the incident light or the exit light can be polarized with a predetermined wavelength.

The transparent electrode 15 is formed on the other surface of the upper substrate 16. The transparent electrode 15 may be made of a transparent conductive oxide. In addition, the transparent electrode 15 may be made of ITO or IZO.

Referring to FIGS. 3 and 4, the transparent electrode 15 includes the first electrode 15a and the second electrode 15b arranged alternately, and drives the liquid crystals LC by generating an electric field in response to different voltages applied thereto.

Referring to FIGS. 5A and 5B, the transparent electrode 15 drives the injected liquid crystals LC in an in-plane switching (IPS) mode. When driving voltages are applied to the first electrode 15a and the second electrode 15b which constitute the transparent electrode 15, an electric field is generated between the first electrode 15a and the second electrode 15b so as to rotate the liquid crystals LC in a certain direction. On the other hand, when the application of the driving voltages to the first electrode 15a and the second electrode 15b is blocked, the liquid crystals LC remain stationary.

That is, referring to FIG. 6, the reflective type complex display device according to the current exemplary embodiment can drive the liquid crystals LC using the transparent electrode 15 formed on a surface of the upper substrate 16, and does not require an additional electrode on the organic light-emitting layer 12 to form an electric field. Hence, the reflective type complex display device in which element reliability and stability of the organic light-emitting layer 12 are improved can be provided.

The reflective type complex display device according to the current exemplary embodiment may further include an optical sensor (not shown) for sensing external light and a control unit (not shown) for applying a voltage to one or more of the transparent electrode 15 and the organic light-emitting layer 12 according to the intensity of the external light received by the optical sensor.

The reflective type complex display device according to the current exemplary embodiment can be driven in a reflective type liquid crystal mode and an organic light-emitting mode. Therefore, the optical sensor may sense external light, and the control unit may determine whether to drive the reflective type complex display device in the reflective type liquid crystal mode, in the organic light-emitting mode, or in both the reflective type liquid crystal mode and the organic light-emitting mode based on the intensity of the external light.

When the intensity of the external light exceeds a predetermined value, the control unit drives the liquid crystals LC by applying a voltage to the transparent electrode 15. When the intensity of the external light does not exceed the predetermined value, the control unit controls the organic light-emitting layer 12 so as to emit light by applying a voltage to the organic light-emitting layer 12. The predetermined value is an arbitrary value and is a reference value which can be adjusted according to the setting of or the intensity of illumination in the organic light-emitting mode.

Since the reflective type complex display device according to the current exemplary embodiment can control the organic light-emitting mode by sensing external light, it can maintain high contrast even when the external light is very intense.

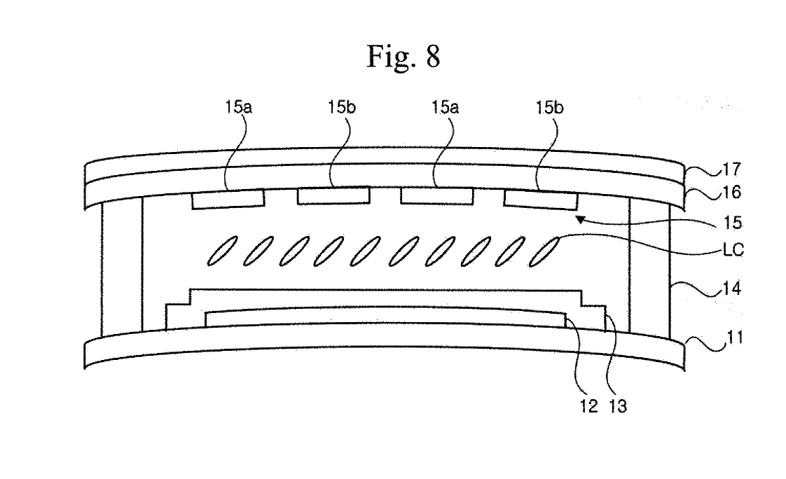

Hereinafter, a reflective type complex display device according to another exemplary embodiment of the present invention will be described with reference to FIG. 8.

FIG. 8 is a cross-sectional view of a reflective type complex display device according to another exemplary embodiment of the present invention.

The reflective type complex display device according to the current exemplary embodiment includes a flexible lower substrate 11, an organic light-emitting layer 12 formed on a top surface of the lower substrate 11 and emitting light when supplied with current, a thin organic complex sealing layer 13 covering the organic light-emitting layer 12 so as to seal the organic light-emitting layer 12 from the outside, a flexible upper substrate 16 formed above the sealing layer 13 with a gap therebetween, liquid crystals LC injected between the upper substrate 16 and the sealing layer 13, a transparent electrode 15 formed on a surface of the upper substrate 16, and a polarizer 17 formed on the other surface of the upper substrate 16. The transparent electrode 15 includes a first electrode 15a and a second electrode 15b which are alternately arranged, and which drive the liquid crystals LC by generating an electric field in response to different voltages applied thereto.

The reflective type complex display device according to the current exemplary embodiment of the invention is the same as the reflective type complex display device according to the previous exemplary embodiment, except that it is a flexible, reflective type complex display device since the lower substrate 11 and the upper substrate 16 are made of a flexible material. The flexible lower substrate 11 and the flexible upper substrate 16 can be made of any material. In this case, the sealing layer 13 disposed on the lower substrate 11 may also be made of a flexible material, specifically, a complex of an organic material or a complex of an inorganic material. The transparent electrode 15 and the polarizer 17 can be made of any material which is flexible.

Since the lower substrate 11 and the upper substrate 16 included in the reflective type complex display device according to the current exemplary embodiment are made of a flexible material, the reflective type complex display device according to the current exemplary embodiment is flexible and can maintain high contrast by selectively driving the liquid crystals LC according to the intensity of external light.

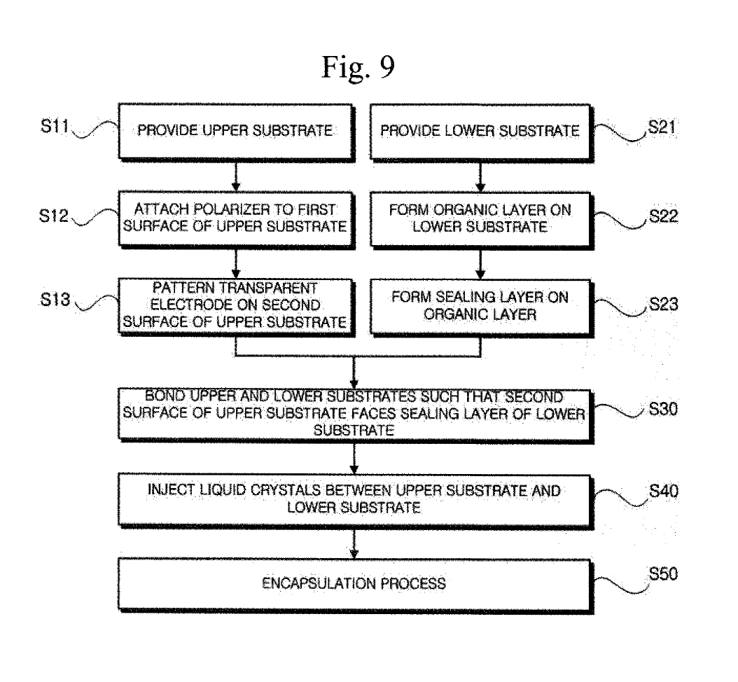

Hereinafter, a method of manufacturing a reflective type complex display device according to an exemplary embodiment of the present invention will be described with reference to FIG. 9.

FIG. 9 is a flowchart illustrating a method of manufacturing a reflective type complex display device according to an exemplary embodiment of the present invention.

The method of manufacturing a reflective type complex display device according to the current exemplary embodiment includes providing an upper substrate and a lower substrate (operations S11 and S21), forming an organic light-emitting layer on the lower substrate (operation S22), forming a sealing layer on the organic light-emitting layer (operation S23), forming a patterned transparent electrode on a surface of the upper substrate (operation S13), bonding the upper substrate and the lower substrate together so that the surface of the upper substrate faces the sealing layer of the lower substrate (operation S30), and injecting liquid crystals between the upper substrate and the lower substrate (operation S40). The transparent electrode includes a first electrode and a second electrode which are alternately arranged, and which drive the liquid crystals by generating an electric field in response to different voltages applied thereto.

The details of the method of manufacturing a reflective type complex display device according to the current exemplary embodiment are substantially the same as those described previously, and thus a repetitive description thereof is omitted. As described above, in the method of manufacturing a reflective type complex display device according to the current exemplary embodiment, the transparent electrode is formed only on the upper substrate but not on the organic light-emitting layer. This prevents damage to the organic light-emitting layer, which, in turn, prevents luminance non-uniformity or deterioration of element reliability.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

What is claimed is:

1. A reflective type complex display device, comprising:
a lower substrate;
an organic light-emitting layer formed on a top surface of the lower substrate for emitting light when supplied with current;
a sealing layer covering the organic light-emitting layer so as to seal the organic light-emitting layer from the outside;
an upper substrate formed above the sealing layer with a gap therebetween;
liquid crystals injected between the upper substrate and the sealing layer;
a transparent electrode formed on a surface of the upper substrate; and
a polarizer formed on another surface of the upper substrate;
wherein the transparent electrode comprises a first electrode and a second electrode which are alternately arranged, and which drive the liquid crystals by generating an electric field in response to different voltages applied thereto.

2. The display device of claim 1, wherein the organic light-emitting layer comprises a hole injecting layer, a hole transporting layer, an emitting layer, an electron transporting layer, and an electron injecting layer.

3. The display device of claim 2, wherein the organic light-emitting layer further comprises an anode electrode formed on a bottom surface of the hole injecting layer and a cathode electrode formed on a top surface of the electron injecting layer.

4. The display device of claim 2, wherein the organic light-emitting layer further comprises an auxiliary hole transporting layer.

5. The display device of claim 1, wherein the transparent electrode is made of a transparent conductive oxide.

6. The display device of claim 1, wherein the transparent electrode is made of one of ITO and IZO.

7. The display device of claim 1, further comprising:
an optical sensor for sensing external light; and
a control unit for applying a voltage to at least one of the transparent electrode and the organic light-emitting layer according to the intensity of the external light sensed by the optical sensor.

8. The display device of claim 7, wherein when the intensity of the external light exceeds a predetermined value, the control unit drives the liquid crystals by applying a voltage to the transparent electrode.

9. The display device of claim 7, wherein when the intensity of the external light does not exceed a predetermined value, the control unit controls the organic light-emitting layer so as to emit light by applying a voltage to the organic light-emitting layer.

10. A reflective type complex display device, comprising:
a flexible lower substrate;
an organic light-emitting layer formed on a top surface of the lower substrate for emitting light when supplied with current;
a thin organic complex sealing layer covering the organic light-emitting layer so as to seal the organic light-emitting layer from the outside;
a flexible upper substrate formed above the sealing layer with a gap therebetween;
liquid crystals injected between the upper substrate and the sealing layer;
a transparent electrode formed on a surface of the upper substrate; and
a polarizer formed on another surface of the upper substrate;
wherein the transparent electrode comprises a first electrode and a second electrode which are alternately arranged, and which drive the liquid crystals by generating an electric field in response to different voltages applied thereto.

11. The display device of claim 10, wherein the organic light-emitting layer comprises a hole injecting layer, a hole transporting layer, an emitting layer, an electron transporting layer, and an electron injecting layer.

12. The display device of claim 11, wherein the organic light-emitting layer further comprises an anode electrode formed on a bottom surface of the hole injecting layer and a cathode electrode formed on a top surface of the electron injecting layer.

13. The display device of claim 11, wherein the organic light-emitting layer further comprises an auxiliary hole transporting layer.

14. The display device of claim 10, wherein the transparent electrode is made of a transparent conductive oxide.

15. The display device of claim 10, wherein the transparent electrode is made of one of ITO and IZO.

16. The display device of claim 10, further comprising:
an optical sensor for sensing external light; and
a control unit for applying a voltage to at least one of the transparent electrode and the organic light-emitting layer according to the intensity of the external light sensed by the optical sensor.

17. The display device of claim 16, wherein when the intensity of the external light exceeds a predetermined value, the control unit drives the liquid crystals by applying a voltage to the transparent electrode.

18. The display device of claim 16, wherein when the intensity of the external light does not exceed a predetermined value, the control unit controls the organic light-emitting layer so as to emit light by applying a voltage to the organic light-emitting layer.

19. A method of manufacturing a reflective type complex display device, the method comprising the steps of:
providing an upper substrate and a lower substrate;
forming an organic light-emitting layer on the lower substrate;
forming a sealing layer on the organic light-emitting layer;
forming a patterned transparent electrode on a surface of the upper substrate;
bonding the upper substrate and the lower substrate together so that the surface of the upper substrate faces the sealing layer of the lower substrate; and
injecting liquid crystals between the upper substrate and the lower substrate;
wherein the transparent electrode comprises a first electrode and a second electrode which are alternately arranged, and which drive the liquid crystals by generating an electric field in response to different voltages applied thereto.

20. The method of claim 19, wherein the step of forming the organic light-emitting layer comprises sequentially forming a hole injecting layer, a hole transporting layer, an emitting layer, an electron transporting layer, and an electron injecting layer.

21. The method of claim 20, wherein the step of forming the organic light-emitting layer further comprises forming an anode electrode on a bottom surface of the hole injecting layer and forming a cathode electrode on a top surface of the electron injecting layer.

22. The method of claim 20, wherein the step of forming the organic light-emitting layer further comprises forming an auxiliary hole transporting layer.

23. The method of claim 19, wherein the transparent electrode is made of a transparent conductive oxide.

24. The method of claim 19, wherein the transparent electrode is made of one of ITO and IZO.

25. The method of claim 19, further comprising the steps of:
forming an optical sensor which senses external light; and
forming a control unit which applies a voltage to at least one of the transparent electrode and the organic light-emitting layer according to the intensity of the external light sensed by the optical sensor.

26. The method of claim 19, further comprising the step of forming a polarizer on another surface of the upper substrate.
